(19) United States
(12) Patent Application Publication
(10) Pub. No.: US 2014/0262988 A1
(43) Pub. Date: Sep. 18, 2014

(54) Water Filtration Tower

(71) Applicant: Ramana Venkata Rao Sistla, Hyderabad (IN)

(72) Inventor: Ramana Venkata Rao Sistla, Hyderabad (IN)

(21) Appl. No.: 14/215,545

(22) Filed: Mar. 17, 2014

Related U.S. Application Data
(60) Provisional application No. 61/788,945, filed on Mar. 15, 2013.

(51) Int. Cl. B01D 29/56; B01D 29/60

(52) U.S. Cl. CPC B01D 29/56; B01D 29/606; C02F 1/001
USPC 210/90; 210/201; 210/136; 210/134

(57) ABSTRACT

A village water filtration system includes a vertical tube which can be filled with non-potable water, attached to a human powered or other air pressurization source, the pressurized air forcing the flow of the water out of the tube and through a series of filters, producing potable water. The air pressurization source may be a common bicycle pump. The filtration media would be attached by a pipe proximal the lower chamber of the tube, whereas water and pressurized air would enter proximal the top of the tube. A series of check valves prevents the pressurized air and water from exiting anywhere except through the series of filters. Accessory ports for placing eater treatment chemicals may be provided. A clean out port is provided near the bottom of the vertical tube to remove sediment which may accumulate there. Advanced models may employ UV light, ozonation or other water cleaning devices and techniques.

### RELATED APPLICATIONS

This utility patent claims priority from Provisional Patent Application Ser. No. 61/788,945 filed on Mar. 15, 2013 entitled “Water Filtration Tower” which is incorporated herein in its entirety.

### BACKGROUND OF THE INVENTION

There is an ongoing commitment to alleviating the desperate condition of poor, under-served people, especially in the rural areas of the developing world by providing safe drinking water. United Nations reports show that more than a billion people worldwide are without potable water, and as a result, five million men, women, and children die from waterborne diseases every year. The World Health Organization's Water, Sanitation and Health branch wrote that an adequate supply of safe drinking water is universally recognized as a basic human need. The health consequences resulting from the inequity of poor services are sometimes considerable, as evidenced by the infant mortality rates which may vary between two and ten times in magnitude between those served with good water supplies and those which are not. The poor, in particular, are at high risk from endemic diarrheal diseases, such as cholera.

Sanitary engineers have witnessed this devastation first-hand. It is easier in many parts of the world to find a gallon of clean gasoline than clean water. Building sustainable water treatment and delivery infrastructure for all peoples of the world is the ultimate goal. However, given the enormous costs, engineering effort and political will required, this goal may never be achieved. An interim solution is needed, and the need is dire. Throughout the third world, one can witness first hand the devastation that is wrought by the lack of clean water for the families. A human powered, point of service, water filtration device, which could generate potable water, may not be a panacea, but would certainly be an improvement over current conditions.

### BRIEF DESCRIPTION OF THE DRAWINGS

FIG. 1 is a schematic view of a first embodiment of the present invention.

FIG. 2 is a schematic view of a second embodiment of the present invention.

### DESCRIPTION OF THE PREFERRED EMBODIMENT

FIG. 1 shows and discloses a tube 1 containing water to develop hydrostatic pressure. The tube may be filled from the top 2 by a natural source located at a higher location than the terrain on which the device is installed, or by manual labor that may climb a hill or a building or a structure specifically designed and built for this purpose, or may be filled with a combination of pumps that may utilize renewable energy sources such as wind or solar. It may also be manually filled from roof tanks which collect rain water channeled from a roof to a collection container. The tube may be as high as a few feet to tens of feet depending on the specific requirements of the filtration or reverse osmosis media. The tube incorporates a back-flow preventer 3 which allows flow of water downward but not in the upward direction.

Just above the back-flow preventer, water from section 4 is directed to an outlet tube 5 which may be any size depending on local requirements and other parameters, but is envisioned to be between 1/2″ to 3/4″ in diameter made from PVC or copper or brass or galvanized is connected to the inlet of a pump 6 which can be manually operated or operated through a chain or pulley arrangement with a bicycle wheel or other locally available rotational torque generating device. The outlet of the above described pump 6 is then reconnected at point 7 to the vertical tube assembly but below 8 the back-flow preventer. This arrangement allows pressure to be generated in the volume below the back-flow preventer 8 which is higher than the pressure above the back flow preventer in section 4. The addition of these 2 pressures results in a pressure that is equal to the sum of the hydrostatic pressure above the back-flow preventer at the point where tube 5 is located, plus the differential pressure generated by the hand-pump (6).

The pressure of the water in section 8 is now at a sufficiently high relative level to overcome the pressure requirements of one or more filtration media. The filters may include a variety of filter types for sediment or bacteria or harmful substances such as arsenic or fluoride, and it may also include a reverse osmosis filter assembly if required. The configuration of how the filter housings (9) are arranged may vary but one specific design where the output from volume 8 is piped to the first filter assembly (10) through a piping arrangement (11) to a second filter assembly (12) and then a third filter assembly (13) and to an outlet spigot (14) is shown. However any piping arrangement that uses the high pressure generated in volume 8 to overcome the operating pressure requirements of filter or filters and produce filtered water at the spigot 14 is claimed.

Referring now to FIG. 2 a second embodiment of the present invention is shown. A vertical cylindrical water tube 105 has an upper water chamber 110 and a lower water chamber 120. The lower water chamber 120 of the water tube 105 is sealed against water and pressure by a bottom sealing cap 125. The upper water chamber 110 of the water tube 105 is also sealed against water and pressure by top sealing cap 135. A check valve 130 is provided intermediate the upper water chamber 110 and the lower water chamber 120, the check valve 130 prevents any water which passes from the upper water chamber 110 into the lower water chamber 120 remains in the lower water chamber 120.

A tube 140 for allowing pressurized air to enter the upper water chamber 110 is shown in parallel relation to the vertical cylindrical water tube 105. Tube 140 includes a pressurized air check valve 145 which allows pressurized air to travel up tube 140 where it enters the upper water chamber 110 through a central opening 150 in the top sealing cap 135. A water inlet pipe 160 enters the upper water chamber 110 proximal the top sealing cap 135. A water inlet check valve 165 permits water to flow into the upper water chamber 110, but will not permit the water to flow back out of the water inlet pipe 160.

An upper water chamber 110 pressure gauge 170 is provided for determining the pressure in said chamber 110. The upper water chamber 110 includes an upper chamber accessory access 175.

The lower water chamber 120 also includes a lower water chamber 120 accessory access 180. The upper accessory access 175 and lower accessory access 180 may be used for, but not limited to, adding chemicals to soften hard water, adding extra pressurization, adding sterilizing chemicals, taking samples, adding helpful bacteria, adding flocculation agents, removing contaminants, neutralizing arsenic and other heavy metals and other such as uses.

A clean-out outlet 190 is provided on the lower water chamber 190 in order to remove sediments, particulates, and any thing else which may settle out of the per-filtered water.

A filter outlet 200 is also provided on the lower water chamber 120. A first filter 210, a second filter 220 and a third filter 230 are located intermediate the filter outlet 200 and an outlet spigot 240. A filter condition gauge 225 is located intermediate the second filter 220 and the third filter 230. By monitoring the pressure on the filter condition gauge 225 one may determine the condition of the filter and whether it requires changing or not. The filters may include a variety of filter types for sediment or bacteria or harmful substances such as arsenic or heavy metals, and it may also include a reverse osmosis filter assembly if required.

In operation, water from any of a variety of sources are introduced through the water inlet 160. A pressurized air generator 250 is affixed to the pressurized air tube 140 and the water in the upper water chamber 110 becomes pressurized, passing through the check valve 130 into the lower water chamber 120. The pressurized air generator 250 may include, but is not limited to, a bicycle pump, a foot pump, a hand pump, treadle pump, or other human powered pumps. Pumps which employ windmills or solar power to pressurize the air are also considered part of the invention. When the pressure generated by the pressurized air being input into the system overcomes the frictional opposition to the flow caused by the filter media in the first filter 210, second filter 220 and third filter 230, the non potable water flows through the first filter 210, second filter 220 and third filter 230 and potable water flows from the output spigot 240.

In some cases the water may be pre-treated or post-treated by LED Ultraviolet light or an ozonator.

The preferred embodiment of the invention is directed to a water filtration system including a water flow tube having a sidewall, the water flow tube having a top cover and a bottom cover, the top cover and said bottom cover sealing an interior of said water flow tube, a pressurized air tube, the pressurized air tube having a distal end and a proximal end, the distal end connected to said interior of said water flow tube through the top cover, the proximal end connected to an air pressure generator, a water entry tube, the water entry tube having a first end and a second end, the second end connected to said interior of the water entry tube through the top cover, a plurality of filters affixed in series to a filter entry pipe and a filter exit pipe, the filter entry pipe connected to said interior of the water flow tube through the sidewall proximal the bottom cover; whereby when said tube is filled with non-potable water, air is forced into the pressurized air tube by the air pressure generator, and the pressurized air flows into the water flow tube through said distal end, forcing the non-potable water through said plurality of filters which remove contaminants from the non-potable water, creating potable water, the potable water exiting through the filter exit pipe ready for consumption.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A water filtration system including:
a water flow tube having a sidewall, said water flow tube having a top cover and a bottom cover, said top cover and said bottom cover sealing an interior of said water flow tube,
a pressurized air tube, said pressurized air tube having a distal end and a proximal end, said distal end connected to said interior of said water flow tube through said top cover, said proximal end connected to an air pressure generator,
a water entry tube, said water entry tube having a first end and a second end, said second end connected to said interior of said water entry tube through said top cover,
a plurality of filters affixed in series to a filter entry pipe and a filter exit pipe, said filter entry pipe connected to said interior of said water flow tube through said sidewall proximal said bottom cover; whereby when said tube is filled with non-potable water, air is forced into said pressurized air tube by said air pressure generator, and the pressurized air flows into said water flow tube through said distal end, forcing the non-potable water through said plurality of filters which remove contaminants from the non-potable water, creating potable water, the potable water exiting through said filter exit pipe ready for consumption.

2. A water filter system as claimed in claim 1 wherein said water flow tube includes an upper water chamber and a lower water chamber.

3. A water filter system as claimed in claim 2 wherein a water flow tube check valve is provided intermediate said upper water chamber and said lower water chamber.

4. A water filter system as claimed in claim 3 wherein a pressurized air check valve is provided intermediate said distal end and said proximal end of said pressurized air tube.

5. A water filtration system as claimed in claim 4 wherein a water entry tube check valve is provided intermediate said first end and said second end of said water entry tube.

6. A water filtration system as claimed in claim 5 wherein said upper water chamber includes a upper water chamber access port, said upper water chamber access port passes through said sidewall of said upper water chamber, said upper water chamber access port having a first resealable cover element, said first resealable cover element prevents any pressurized water from escaping.

7. A water filtration system as claimed in claim 6 wherein said lower water chamber includes a lower water chamber access port, said lower water chamber access port passes through said sidewall of said lower water chamber, said lower water chamber access port having a second resealable cover element, said second resealable cover element prevents any pressurized water from escaping.

8. A water filtration system as claimed in claim 7 wherein a first pressure gauge is provided on said upper water chamber, allowing a first pressure readout to be made.

9. A water filter system as claimed in claim 8 wherein a clean-out access port is provided on said lower water chamber proximal said bottom cover.

10. A water filtration system as claimed in claim 9 wherein said clean-out access port is provided with a third resealable cover, said third resealable cover able to withstand any pressure level generated in said lower water chamber.

11. A water filtration system as claimed in claim 10 wherein said clean-out access port is opened by removing said third resealable cover, permitting the removal of any sediment or undesirable material which may have settled on said interior proximal said bottom cover of said water tube.

12. A water filtration system as claimed in claim 11 wherein said water tube is generally cylindrical and is vertically oriented.

13. A water filtration system as claimed in claim 12 where said plurality of filters include a first filter closest to said water tube, a second filter and a third filter.

14. A water filtration system as claimed in claim 13 wherein a second pressure gauge is provided intermediate said second filter and said third filter, said second pressure gauge having an indicia thereon, said indicia indicating a pressure value which indicates it is time to change said filters.

15. A water filtration system as claimed in claim 14 wherein said upper water chamber access port is opened by removing said first resealable cover, permitting an action selected from the group consisting of adding chemicals to soften hard water, adding extra pressurization, adding sterilizing chemicals, taking samples, adding helpful bacteria, adding flocculation agents, removing contaminants, neutralizing arsenic and other heavy metals.

16. A water filtration system as claimed in claim 15 wherein said lower water chamber access port is opened by removing said second resealable cover, permitting an action selected from the group consisting of adding chemicals to soften hard water, adding extra pressurization, adding sterilizing chemicals, taking samples, adding helpful bacteria, adding flocculation agents, removing contaminants, neutralizing arsenic and other heavy metals.

17. A water filtration system as claimed in claim 16 wherein said air pressure generator is selected from the group consisting of a bicycle pump, a foot pump, a hand pump, a treadle pump, a solar powered pump, a windmill powered pump, a gasoline powered pump or an electrically powered pump.
